(19) United States
(12) Patent Application Publication
(10) Pub. No.: US 2024/0021956 A1
(43) Pub. Date: Jan. 18, 2024

(54) BATTERY CELL AND BATTERY

(71) Applicant: Ningde Amperex Technology Limited, Ningde (CN)

(72) Inventors: Yangyu ZHAO, Ningde (CN); Zuzhen GONG, Ningde (CN); Xin JIN, Ningde (CN)

(73) Assignee: Ningde Amperex Technology Limited, Ningde (CN)

(21) Appl. No.: 18/374,753

(22) Filed: Sep. 29, 2023

Related U.S. Application Data
(63) Continuation of application No. PCT/CN2021/083971, filed on Mar. 30, 2021.

(51) Int. Cl. H01M 50/457; H01M 50/46; H01M 10/04; H01M 50/105

(52) U.S. Cl. CPC H01M 50/457; H01M 50/461; H01M 10/0431; H01M 50/105

(57) ABSTRACT

An electrode assembly, where an outer surface of the electrode assembly includes a first surface, a first end face, a second surface, and a second end face that are connected in sequence, the first surface is provided opposite to the second surface, and the first end face is provided opposite to the second end face; a first adhesive layer, where the first adhesive layer is adhered to the first end face and extends from the first end face to the first surface and the second surface separately, and a side of the first surface provided with the first adhesive layer is defined as a top side; and a second adhesive layer, where the second adhesive layer is adhered to the second end face and extends from the second end face to the first surface and the second surface separately.

### CROSS-REFERENCE TO RELATED APPLICATION

This application is the continuation application of PCT international application: PCT/CN2021/083971 filed on Mar. 30, 2021, the disclosure of which is hereby incorporated by reference in its entirety.

### TECHNICAL FIELD

This application relates to the field of battery technologies, and in particular, to a battery cell and a battery.

### BACKGROUND

A battery cell typically includes an electrode assembly and an encapsulating film. To avoid a problem of electrolyte leakage caused by a seal of an encapsulating film being broken by the electrode assembly when the battery cell drops due to various reasons, one surface of the electrode assembly is typically adhered to the encapsulating film by using double-sided adhesive tape or hot-melt adhesive.

In a process of implementing this application, the inventors have found that there are at least the following problems in the prior art: when the encapsulating film drops and deforms, an electrolyte accumulated in the encapsulating film creates a strong impact on the outermost separator in the electrode assembly. Contraction of the separator is likely to occur at positions on a top side or a bottom side of the electrode assembly without protection of adhesive, which causes internal short circuit in the electrode assembly, thereby affecting drop performance of the battery cell.

### SUMMARY

In view of this, it is necessary to provide a battery cell with improved drop performance, and a battery using the battery cell.

An embodiment of this application provides a battery cell. The battery cell includes an electrode assembly, a first adhesive layer, and a second adhesive layer. An outer surface of the electrode assembly includes a first surface, a first end face, a second surface, and a second end face that are connected in sequence, the first surface is provided opposite the second surface, and the first end face is provided opposite the second end face. The first adhesive layer is adhered to the first end face and extends from the first end face to the first surface and the second surface separately, and a side of the first surface provided with the first adhesive layer is defined as a top side. The second adhesive layer is adhered to the second end face and extends from the second end face to the first surface and the second surface separately, and a side of the first surface provided with the second adhesive layer is defined as a bottom side. The battery cell further includes a first adhesive film and a second adhesive film. The first adhesive film is adhered to the top side and/or the bottom side. The second adhesive film is adhered to the first surface, and two ends of the second adhesive film are adhered to the top side and the bottom side respectively. A first adhesive force between the first adhesive film and the first surface is greater than a second adhesive force between the second adhesive film and the first surface.

In a possible implementation, in a width direction of the electrode assembly, the first adhesive film has a first overlapping portion with the second adhesive film, and a width of the first overlapping portion ranges from 0.1 mm to 15 mm.

In a possible implementation, the outer surface of the electrode assembly further includes a first side face and a second side face opposite the first side face, and the first side face and the second side face are respectively provided between the first surface and the second surface. The second adhesive layer is disposed between the second adhesive film and the first side face. The battery cell further includes a third adhesive layer, the third adhesive layer is adhered to the second end face and extends from the second end face to the first surface and the second surface respectively, and the third adhesive layer is disposed between the second adhesive film and the second side face. In the width direction of the electrode assembly, the second adhesive layer and/or the third adhesive layer respectively have a second overlapping portion with the second adhesive film, and a width of the second overlapping portion ranges from 0.1 mm to 15 mm.

In a possible implementation, the first adhesive film is disposed between the second adhesive layer and the first side face, and/or between the third adhesive layer and the second side face.

In a possible implementation, the first adhesive film has a third overlapping portion between the bottom side and the second adhesive layer and/or between the bottom side and the third adhesive layer, and a width of the third overlapping portion ranges from 0.1 mm to 15 mm.

In a possible implementation, the electrode assembly is formed by stacking or winding an anode electrode plate, a separator, and a cathode electrode plate that are disposed in sequence. In a length direction of the electrode assembly, two sides of the anode electrode plate exceed beyond two corresponding sides of the cathode electrode plate. Two sides of the separator respectively exceed beyond two corresponding sides of the anode electrode plate. The first surface is one side of the outermost cathode electrode plate in the electrode assembly. In addition, in the length direction of the electrode assembly, one side of the first adhesive film is adhered to the first surface, and the other side is adhered to an area of the outermost separator in the electrode assembly that exceeds beyond the corresponding cathode electrode plate and that does not exceed beyond an end face of the corresponding separator.

In a possible implementation, a product of an overlapping area between the first adhesive film and the separator and an adhesive force therebetween is defined as a third adhesive force, a product of an overlapping area between the cathode electrode plate and the separator and an adhesive force therebetween is defined as a fourth adhesive force, and the third adhesive force is greater than the fourth adhesive force.

In a possible implementation, the adhesive force between the first adhesive film and the separator is greater than or equal to 0.05 N/mm, and/or an adhesive force between the first adhesive film and the cathode electrode plate is greater than or equal to 0.05 N/mm.

In a possible implementation, the battery cell further includes a fourth adhesive layer adhered to the second surface, the second surface is a surface on which a terminating end of the electrode assembly is located, one end of the first adhesive layer is adhered to one end of the second adhesive film located on the top side, the other end of the first adhesive layer is adhered to one end of the fourth adhesive layer, and the second adhesive layer on the second surface is adhered to the other end of the fourth adhesive layer.

In a possible implementation, the battery cell includes an encapsulating film. The encapsulating film includes a first groove and a second groove that are configured to accommodate the electrode assembly. A depth of the first groove is less than that of the second groove. The first surface is opposite a bottom face of the first groove, and the second surface is opposite a bottom face of the second groove.

Another embodiment of this application further provides a battery, including a housing and any one of the foregoing battery cells. The battery cell is disposed in the housing.

In the battery cell provided in the embodiments of this application, the first adhesive layer and the second adhesive layer are respectively adhered to two opposite end faces of the electrode assembly to fix positions between the electrode plates of each layer of the electrode assembly. The outermost electrode plate at an area corresponding to the first adhesive film and the second adhesive film and the separator are connected by using the corresponding first adhesive film to form a whole. The first adhesive force between the first adhesive film and the first surface is greater than or equal to the second adhesive force between the second adhesive film and the first surface, so that a difference between a first connection strength and a second connection strength is reduced, so as to avoid the electrode plate being torn caused by the first surface being subject to an unbalanced force due to an excessive difference between the first connection strength and the second connection strength and short circuit caused by contraction of the separator, thereby improving drop performance of the electrode assembly.

### BRIEF DESCRIPTION OF DRAWINGS

FIG. 1 is a schematic diagram of a front-side structure of a battery cell according to an embodiment of this application;

FIG. 2 is a schematic diagram of a rear-side structure of a battery cell according to an embodiment of this application;

FIG. 3 is a schematic diagram of a side structure of a battery cell according to an embodiment of this application;

FIG. 4 is a schematic diagram of a side structure of a battery cell according to an embodiment of this application;

FIG. 5 is a schematic diagram of a front-side structure of a battery cell according to an embodiment of this application;

FIG. 6 is a schematic diagram of a side structure of a battery cell according to an embodiment of this application;

FIG. 7 is a schematic diagram depicting a structure of a first surface of an electrode assembly according to an embodiment of this application;

FIG. 8 is a schematic diagram depicting a structure of an encapsulating film according to an embodiment of this application; and

FIG. 9 is a schematic diagram depicting a cross-sectional structure of a battery cell according to an embodiment of this application.

### REFERENCE SIGNS OF MAIN COMPONENTS

battery cell 100
electrode assembly 10
first surface 11
top side 111
bottom side 112
second surface 12
first end face 13
second end face 14
first side face 15
second side face 16
anode electrode plate 17
separator 18
cathode electrode plate 19
first adhesive layer 20
second adhesive layer 30
first adhesive film 40
first overlapping portion 40a
third overlapping portion 40b
second adhesive film 50
second overlapping portion 50a
third adhesive layer 60
fourth adhesive layer 70
encapsulating film 80
first groove 81
second groove 82
anode tab 91
cathode tab 92

### DETAILED DESCRIPTION

The following describes the technical solutions in the embodiments of this application with reference to the accompanying drawings in the embodiments of this application. Apparently, the described embodiments are only some rather than all of the embodiments of this application.

It should be noted that, when one component is deemed as being “connected to” another component, it can be directly connected to the another component, or there can be a component in between. When one component is deemed as being “disposed on” another component, it can be directly disposed on the another component, or there can be a component in between. The terms “top”, “bottom”, “upper”, “lower”, “left”, “right”, “front”, “rear”, and other similar expressions as used herein are for illustration only.

Unless otherwise defined, all technical and scientific terms used herein shall have the same meanings as commonly understood by those skilled in the art to which this application belongs. The terms used herein in the specification of this application are only used to describe specific embodiments, and are not intended to limit this application.

An embodiment of this application provides a battery cell. The battery cell includes an electrode assembly, a first adhesive layer, and a second adhesive layer. An outer surface of the electrode assembly includes a first surface, a first end face, a second surface, and a second end face that are connected in sequence, the first surface is provided opposite the second surface, and the first end face is provided opposite the second end face. The first adhesive layer is adhered to the first end face and extends from the first end face to the first surface and the second surface separately, and a side of the first surface provided with the first adhesive layer is defined as a top side. The second adhesive layer is adhered to the second end face and extends from the second end face to the first surface and the second surface separately, and a side of the first surface provided with the second adhesive layer is defined as a bottom side. The battery cell further includes a first adhesive film and a second adhesive film. The first adhesive film is adhered to the top side and/or the bottom side. The second adhesive film is adhered to the first surface, and two ends of the second adhesive film are adhered to the top side and the bottom side respectively. A first adhesive force between the first adhesive film and the first surface is greater than a second adhesive force between the second adhesive film and the first surface.

In the battery cell provided in the embodiments of this application, the first adhesive layer and the second adhesive layer are respectively adhered to two opposite end faces of the electrode assembly to fix positions between the electrode plates of each layer of the electrode assembly. The outermost electrode plate at an area corresponding to the first adhesive film and the second adhesive film and the separator are connected by using the corresponding first adhesive film to form a whole. The first adhesive force between the first adhesive film and the first surface is greater than or equal to the second adhesive force between the second adhesive film and the first surface, so that a difference between a first connection strength and a second connection strength is reduced, so as to avoid the electrode plate being torn caused by the first surface being subject to an unbalanced force due to an excessive difference between the first connection strength and the second connection strength and short circuit caused by contraction of the separator, thereby improving drop performance of the electrode assembly.

The following describes in detail some embodiments with reference to the accompanying drawings. In absence of conflicts, the following embodiments and features in the embodiments may be combined.

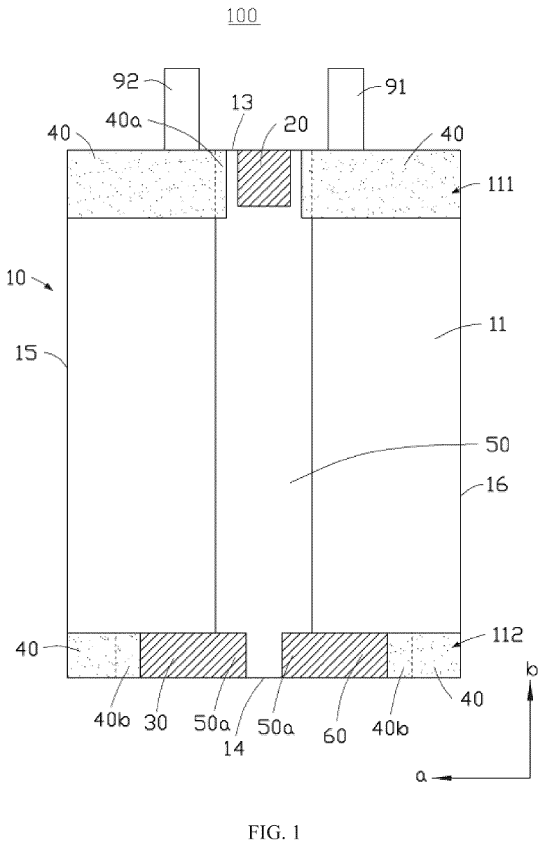

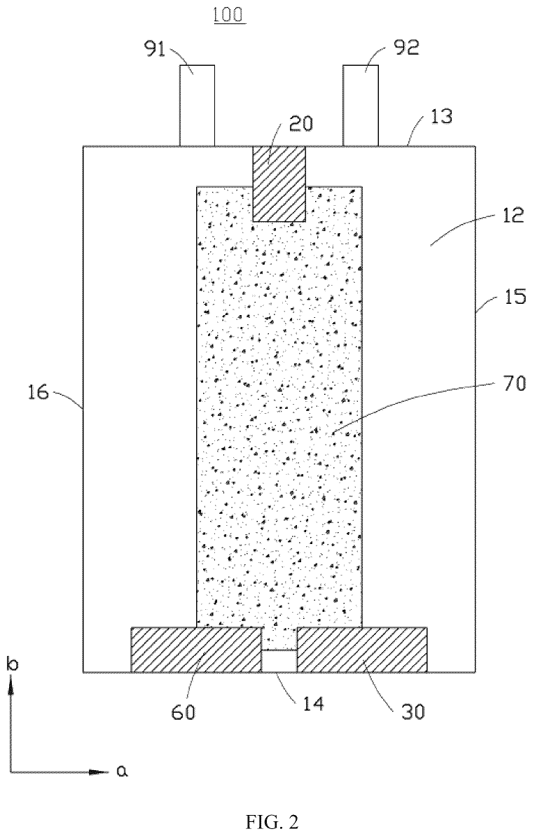

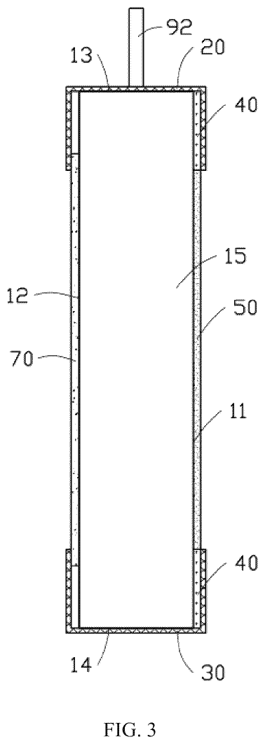

Referring to FIG. 1, FIG. 2, and FIG. 3 together, a battery cell 100 of this embodiment includes an electrode assembly 10, a first adhesive layer 20, a second adhesive layer 30, a first adhesive film 40, and a second adhesive film 50.

An outer surface of the electrode assembly 10 includes a first surface 11, a first end face 13, a second surface 12, and a second end face 14 that are connected in sequence, the first surface 11 is provided opposite the second surface 12, and the first end face 13 is provided opposite the second end face 14. The battery cell 100 further includes an anode tab 91 and a cathode tab 92. Referring to FIG. 1 and FIG. 2, the anode tab 91 and the cathode tab 92 can separately pass through the first end face 13. In some embodiments, the anode tab 91 and the cathode tab 92 can respectively pass through the first end face 13 and the second end face 14.

The first adhesive layer 20 is adhered to the first end face 13 and extends from the first end face 13 to the first surface 11 and the second surface 12 separately. The second adhesive layer 30 is adhered to the second end face 14 and extends from the second end face 14 to the first surface 11 and the second surface 12 separately. The first adhesive layer 20 and the second adhesive layer 30 are respectively adhered to two opposite end faces of the electrode assembly 10 to fix positions between the electrode plates of each layer of the electrode assembly 10, so as to avoid a displacement between the electrode plates of each layer of the electrode assembly 10 causing short circuit when the electrode assembly 10 drops, thereby improving drop performance of the first end face 13 and the second end face 14 of the electrode assembly 10. In some embodiments, the first adhesive layer 20 is adhered to the first end face 13 and located in the middle of a width of the electrode assembly 10.

A side of the first surface 11 provided with the first adhesive layer 20 is defined as a top side 111, and a side of the first surface 11 provided with the second adhesive layer 30 is defined as a bottom side 112. The first adhesive film 40 is adhered to the top side 111 and/or the bottom side 112. The second adhesive film 50 is adhered to the first surface 11, and two ends of the second adhesive film 50 are adhered to the top side 111 and the bottom side 112 respectively. In some embodiments, the first adhesive film 40 and the second adhesive film 50 are one or more of green adhesive, high viscosity green adhesive, high viscosity hot-melt adhesive, or other coatings with similar functions.

Parts of the first adhesive film 40 and the second adhesive film 50 located on the top side 111 are used to protect an area of the top side 111 uncoated with the first adhesive layer 20, and parts of the first adhesive film 40 and the second adhesive film located on the bottom side 112 are used to protect the area of the top side 111 uncoated with the first adhesive layer 20, so that the outermost electrode plate at a corresponding area and the separator are connected by using the corresponding first adhesive film 40 to form a whole. In this way, when the electrode assembly 10 drops, the outermost electrode plate in the electrode assembly 10 being torn at the top side 111 and the bottom side 112 and short circuit caused by contraction of the separator can be avoided, thereby improving drop performance of the electrode assembly 10.

In some embodiments, the two ends of the second adhesive film 50 are adhered to the top side 111 and the bottom side 112 respectively, and are partially adhered to the first adhesive layer 20 and/or the second adhesive layer 30. A first adhesive force between the first adhesive film 40 and the first surface 11 is greater than or equal to a second adhesive force between the second adhesive film 50 and the first surface 11.

A connection strength between the outermost electrode plate at an adhering area of the first adhesive film 40 and the separator is defined as a first connection strength, and a connection strength between the outermost electrode plate at an adhering area of the second adhesive film 50 with the corresponding first adhesive layer 20 and/or the second adhesive layer 30 and the separator is defined as a second connection strength. The first adhesive force between the first adhesive film 40 and the first surface 11 is greater than or equal to the second adhesive force between the second adhesive film 50 and the first surface 11, so that a difference between the first connection strength and the second connection strength is reduced, so as to avoid the electrode plate being torn caused by the first surface being subject to an unbalanced force due to an excessive difference between the first connection strength and the second connection strength and short circuit caused by contraction of the separator, thereby improving drop performance of the electrode assembly 10. In some embodiments, a ratio of the first adhesive force to the second adhesive force is greater than or equal to 1 and less than or equal to 5.

In some embodiments, in a width direction a of the electrode assembly 10, widths of the first adhesive film 40 and the second adhesive film 50 are greater than or equal to 1 mm; and in a length direction b of the electrode assembly 10, the widths of the first adhesive film 40 and the second adhesive film 50 are greater than or equal to 1 mm.

In some embodiments, the first adhesive film 40 and the second adhesive film 50 has a shape such as a rectangle, a square, or an irregular shape.

In the foregoing battery cell 100, the first adhesive layer 20 and the second adhesive layer 30 are respectively adhered to two opposite end faces of the electrode assembly 10 to fix positions between the electrode plates of each layer of the electrode assembly 10. The outermost electrode plate at an area corresponding to the first adhesive film 40 and the second adhesive film 50 and the separator are connected by using the corresponding first adhesive film 40 to form a whole. The first adhesive force between the first adhesive film 40 and the first surface 11 is greater than or equal to the second adhesive force between the second adhesive film 50 and the first surface 11, so that a difference between the first connection strength and the second connection strength is reduced, so as to avoid the electrode plate being torn caused by the first surface being subject to an unbalanced force due to an excessive difference between the first connection strength and the second connection strength and short circuit caused by contraction of the separator, thereby improving drop performance of the electrode assembly 10.

Still referring to FIG. 1, in some embodiments, in the width direction a of the electrode assembly 10, the first adhesive film 40 has a first overlapping portion 40a with the second adhesive film 50. In addition, in the first overlapping portion 40a, the second adhesive film 50 is disposed between the first adhesive film 40 and the first surface 11.

By using the first overlapping portion 40a, the first adhesive film 40 and the second adhesive film 50 cooperate and fully cover an area of the top side 111 of the electrode assembly 10 uncoated with the first adhesive layer 20, and/or an area of the bottom side 112 uncoated with the second adhesive layer 30. The first overlapping portion 40a transfers part of a force acting on the first adhesive film 40 to the second adhesive film 50 when the battery cell 100 drops, which alleviates the impact of the electrode plate and the separator in the electrode assembly 10 on the first adhesive film 40, to avoid the electrode plate in the electrode assembly 10 at an adhering position being torn and short circuit of the battery cell 100 caused by contraction of the separator, thereby effectively improving drop performance of the battery cell 100. In addition, ductility of the first adhesive film 40 and the second adhesive film 50 is better than that of the electrode plate in the electrode assembly 10, which further reduces risks of the electrode plate in the electrode assembly 10 being torn and short circuit caused by contraction of the separator, thereby improving safety performance of the battery cell 100. In some embodiments, a width of the first overlapping portion ranges from 0.1 mm to 15 mm.

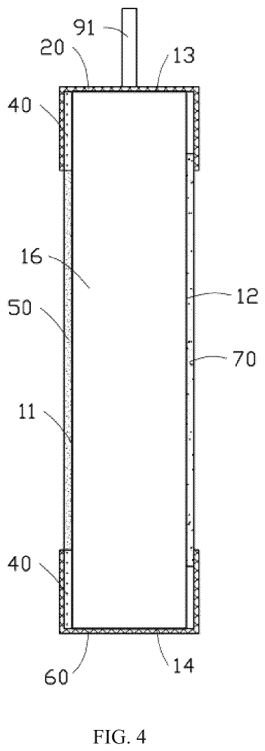

Still referring to FIG. 1, FIG. 2, and FIG. 4 together, in some embodiments, the outer surface of the electrode assembly 10 further includes a first side face 15 and a second side face 16 opposite the first side face 15. The first side face 15 and the second side face 16 are respectively provided between the first surface 11 and the second surface 12. The second adhesive layer 30 is disposed between the second adhesive film and the first side face 15 to fix a position of the electrode plate on the second end face 14 of the electrode assembly 10 near the first side face 15.

In some embodiments, the battery cell 100 further includes a third adhesive layer 60. The third adhesive layer 60 is adhered to the second end face 14 and extends from the second end face 14 to the first surface 11 and the second surface 12 separately. In addition, the third adhesive layer 60 is disposed between the second adhesive film 50 and the second side face 16 to fix a position of the electrode plate on the second end face 14 of the electrode assembly 10 near the second side face 16.

In some embodiments, the second adhesive layer 30 and the third adhesive layer 60 are symmetrically disposed along a middle line of the width of the electrode assembly 10 to ensure that the second adhesive layer 30 and the third adhesive layer 60 are subject to a balanced force, thereby improving stability of fixation of the second adhesive layer 30 and the third adhesive layer 60. The second adhesive layer 30 and the third adhesive layer 60 cooperate to effectively fix the positions of the electrode plates on the second end face 14 of the electrode assembly 10, to avoid a displacement between the electrode plates of each layer of the electrode assembly 10 causing short circuit together with the first adhesive layer 20 when the electrode assembly 10 drops, thereby improving drop performance of the battery cell 100.

It may be understood that in other embodiments, the battery cell 100 further includes a plurality of other adhesive layers adhered to the second end face 14 and extending from the second end face 14 to the first surface 11 and the second surface 12 separately. The second adhesive layer 30, the third adhesive layer 60, and the other adhesive layers are symmetrically disposed along the middle line of the width of the electrode assembly 10.

In some embodiments, in the width direction a of the electrode assembly 10, the second adhesive layer 30 and/or the third adhesive layer 60 respectively have a second overlapping portion 50a with the second adhesive film 50. In addition, in the second overlapping portion 50a, the second adhesive film 50 is disposed between the first surface 11 and the corresponding second adhesive layer 30 or the third adhesive layer 60. The second overlapping portion 50a transfers part of a force acting on the second adhesive layer 30 and/or the third adhesive layer 60 to the second adhesive film 50 when the battery cell 100 drops, which alleviates the impact of the electrode plate and the separator in the electrode assembly 10 on the first adhesive film 40, to avoid the electrode plate in the electrode assembly 10 at an adhering position being torn and short circuit of the battery cell 100 caused by contraction of the separator, thereby effectively improving drop performance of the battery cell 100. In some embodiments, a width of the second overlapping portion 50a ranges from 0.1 mm to 15 mm.

In some embodiments, the first adhesive film 40 is disposed between the second adhesive layer 30 and the first side face 15, and/or between the third adhesive layer 60 and the second side face 16. The first adhesive film 40 has a third overlapping portion 40b between the bottom side 112 and the second adhesive layer 30 and/or between the bottom side 112 and the third adhesive layer 60. In addition, in the third overlapping portion 40b, the second adhesive layer 30 and/or the third adhesive layer are disposed between the first surface 11 and the corresponding first adhesive film

The third overlapping portion 40b connects the first adhesive film 40 and the second adhesive film 50 to the corresponding second adhesive layer 30 or the third adhesive layer 60 to form an overall protection structure located on the bottom side 112, so as to avoid the electrode plate in the electrode assembly 10 at an adhering position at the bottom side 112 being torn and short circuit of the battery cell 100 caused by contraction of the separator when the battery cell 100 drops, thereby effectively improving drop performance of the battery cell 100. In some embodiments, a width of the third overlapping portion 40b ranges from 0.1 mm to 15 mm.

Referring to FIG. 2, FIG. 3, and FIG. 4, the battery cell 100 further includes a fourth adhesive layer 70 adhered to the second surface 12. The second surface 12 is a surface on which a terminating end of the electrode assembly 10 is located. Surfaces of the fourth adhesive layer 70 facing and facing away from the electrode assembly 10 are both adhesive and are used for adhering the electrode assembly 10 to an inner wall of an encapsulating film when the electrode assembly 10 is connected to the encapsulating film accommodating the electrode assembly 10, to prevent the battery cell 100 from electrolyte leakage when the electrode assembly 10 flushes away a seal of the encapsulating film in a drop process, thereby effectively improving drop performance of the battery cell 100. For example, the fourth adhesive layer 70 may be a double-sided adhesive tape. It may be understood that the double-sided adhesive tape may be, but is not limited to, a substance with double-sided adhesive, such as ordinary rubber, hot-melt adhesive, or adhesive paper, and the double-sided adhesive tape may be, but not limited to, a single polymer or a mixture of polymers.

One end of the first adhesive layer 20 is adhered to one end of the second adhesive film 50 located on the top side 111, the other end of the first adhesive layer 20 is adhered to one end of the fourth adhesive layer 70, and the second adhesive layer 30 on the second surface 12 is adhered to the other end of the fourth adhesive layer 70. The first adhesive layer 20, the second adhesive layer 30, and/or the third adhesive layer 60 are adhered to the fourth adhesive layer 70, so that part of a force acting on the first adhesive layer 20, the second adhesive layer 30, and/or the third adhesive layer 60 is transferred to the fourth adhesive layer 70 when the battery cell 100 drops, which alleviates the impact of the electrode plate and the separator in the electrode assembly on the first adhesive layer 20, the second adhesive layer 30, and/or the third adhesive layer 60, to avoid the electrode plate in the electrode assembly 10 at an adhering position being torn and short circuit of the battery cell 100 caused by contraction of the separator, thereby effectively improving drop performance of the battery cell 100.

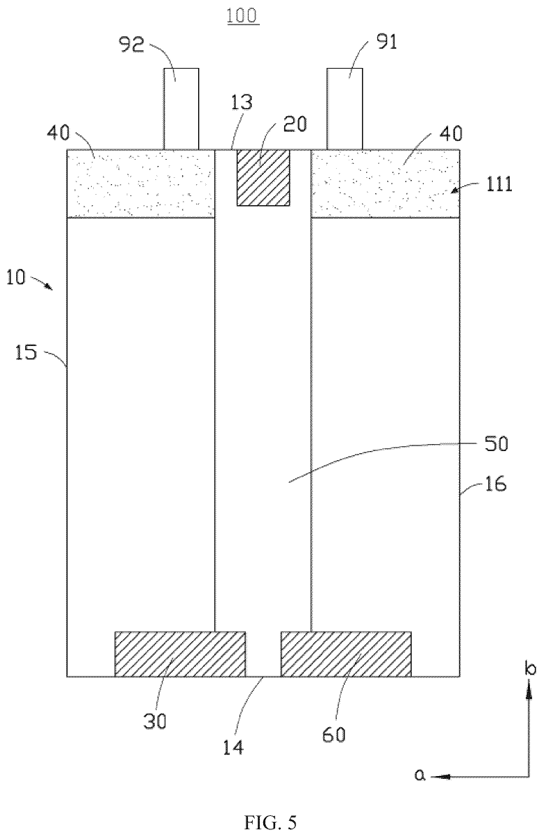

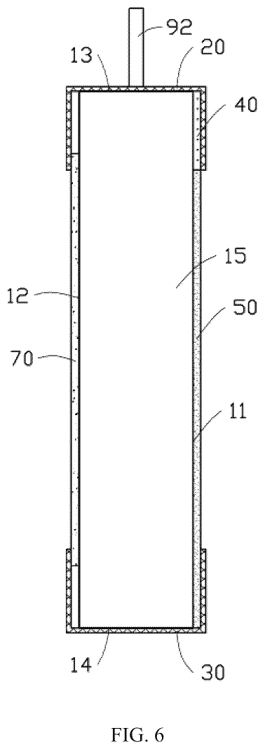

Referring to FIG. 5 and FIG. 6, different from a case in which the first adhesive film 40 is adhered to the top side 111 and the bottom side 112 in FIG. 1, in some embodiments, the first adhesive film 40 is adhered to the top side 111, and the bottom side 112 is fixed by using the second adhesive layer 30 and the third adhesive layer 60. It may be understood that in other embodiments, the first adhesive film 40 is adhered to the bottom side 112, and the top side 111 is fixed by using the second adhesive layer 30 and the third adhesive layer 60.

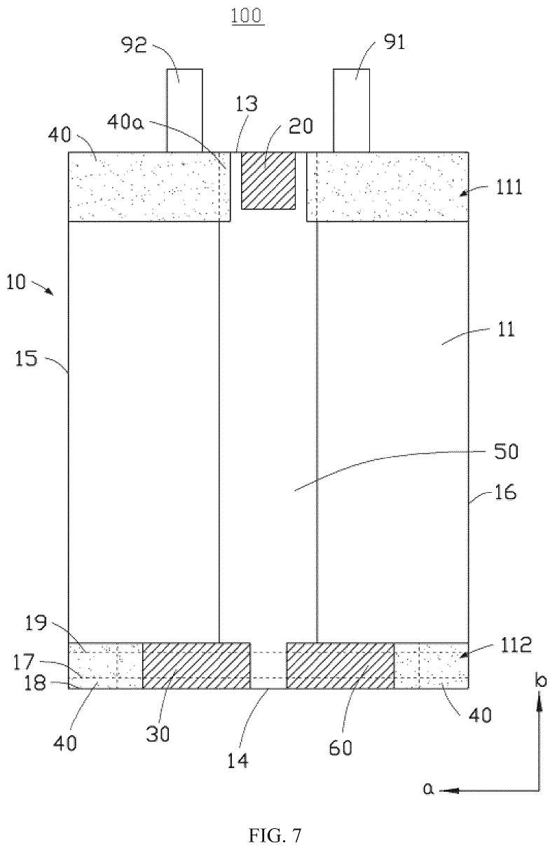

Referring to FIG. 7, the electrode assembly 10 is formed by stacking or winding an anode electrode plate 17, a separator 18, and a cathode electrode plate 19 that are disposed in sequence from the inside out. In a length direction b of the electrode assembly 10, two sides of the anode electrode plate 17 exceed beyond two corresponding sides of the cathode electrode plate 19. Two sides of the separator 18 respectively exceed beyond two corresponding sides of the anode electrode plate 17. The first surface 11 is one side of the outermost cathode electrode plate 19 in the electrode assembly 10.

Using the bottom side 112 of the electrode assembly 10 as an example, in the length direction b of the electrode assembly 10, one side of the first adhesive film is adhered to the first surface 11 (that is, the outermost cathode electrode plate 19 in the electrode assembly 10). The other side is adhered to an area of the outermost separator 18 in the electrode assembly 10 that extends beyond the corresponding cathode electrode plate 19 and that does not exceed beyond an end face of the corresponding separator 18. The cathode electrode plate 19 at the corresponding area and the separator 18 are connected by using the first adhesive film 40 to form a whole, so as to avoid the cathode electrode plate 19 and the separator 18 being torn and short circuit caused by contraction of the separator 18 when the electrode assembly 10 drops, thereby improving drop performance of the electrode assembly 10. In addition, a problem of poor packaging caused by the first adhesive film 40 exceeding beyond the separator 18 can be avoided.

In some embodiments, a product of an overlapping area between the first adhesive film 40 and the separator 18 and an adhesive force therebetween is defined as a third adhesive force, and a product of an overlapping area between the cathode electrode plate 19 and the separator 18 and an adhesive force therebetween is defined as a fourth adhesive force. The third adhesive force is greater than the fourth adhesive force, so as to prevent the contraction of the separator 18 and eversion of the cathode electrode plate 19.

In some embodiments, the adhesive force between the first adhesive film 40 and the separator 18 is greater than or equal to 0.05 N/mm, and/or the adhesive force between the first adhesive film 40 and the cathode electrode plate 19 is greater than or equal to 0.05 N/mm.

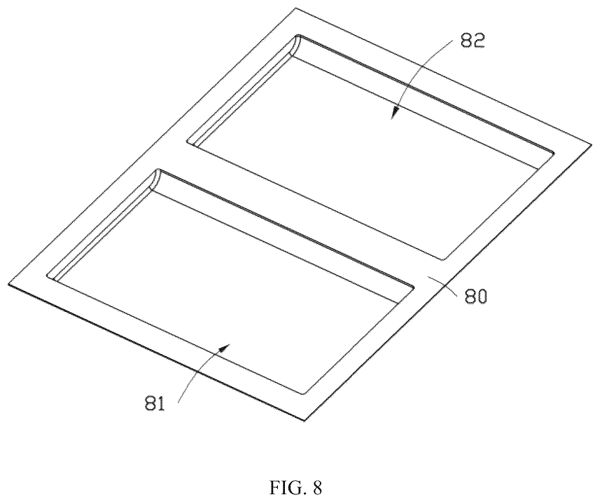

Referring to FIG. 8, the battery cell includes an encapsulating film 80. The encapsulating film 80 includes a first groove 81 and a second groove 82 that are configured to accommodate the electrode assembly. A depth of the first groove 81 is less than that of the second groove 82. The first surface 11 is opposite a bottom face of the first groove 81, and the second surface 12 is opposite a bottom face of the second groove 82.

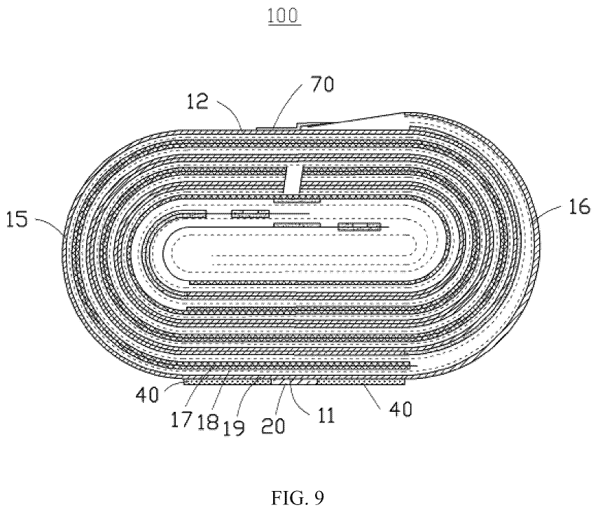

Referring to FIG. 9, in some embodiments, the outermost layer of the first surface 11 is one layer of empty-rolled aluminum foil and two layers of empty-rolled separators, and the layer of empty-rolled aluminum foil and the two layers of empty-rolled separators extend to the corresponding first side face 15 or the second side face 16 in an empty-rolled direction. Compared with an existing method in which the first surface and the second surface are both empty-rolled with a multi-layer aluminum foil and a multi-layer separator, a thickness of the electrode assembly 10 is reduced, and energy density of the battery cell 100 is effectively improved.

An embodiment of this application further provides a battery, including a housing and a battery cell 100 disposed in the housing, and the battery cell 100 may be any battery cell described in the foregoing embodiments. In some embodiments, the battery further includes a circuit protection board, where the circuit protection board is configured to monitor a voltage, a current, a state of insulation, and a state of charge of the battery cell 100, to provide safety management for the charging and discharging process of the battery, alarm and emergency protection for possible faults, and safety and optimal control for operation of the battery.

In addition, those of ordinary skill in the art should be aware of that the foregoing embodiments are only intended to describe this application, but not to limit this application. Appropriate modifications and variations made to the foregoing embodiments without departing from the essential spirit and scope of this application all fall within the scope of this application.

What is claimed is:

1. A battery cell, comprising:
an electrode assembly, a first adhesive layer, a second adhesive layer, a first adhesive film, and a second adhesive film;
wherein an outer surface of the electrode assembly comprises a first surface, a first end face, a second surface, and a second end face that are connected in sequence; the first surface is provided opposite to the second surface, and the first end face is provided opposite to the second end face;
the first adhesive layer is adhered to the first end face and extends from the first end face to the first surface and the second surface separately, and a side of the first surface provided with the first adhesive layer is defined as a top side;
the second adhesive layer is adhered to the second end face and extends from the second end face to the first surface and the second surface separately, and a side of the first surface provided with the second adhesive layer is defined as a bottom side;
the first adhesive film is adhered to the top side and/or the bottom side; and
the second adhesive film is adhered to the first surface, and two ends of the second adhesive film are adhered to the top side and the bottom side respectively;
wherein a first adhesive force between the first adhesive film and the first surface is greater than a second adhesive force between the second adhesive film and the first surface.

2. The battery cell according to claim 1, wherein a ratio of the first adhesive force to the second adhesive force is greater than or equal to 1 and less than or equal to 5.

3. The battery cell according to claim 1, wherein in a width direction of the electrode assembly, the first adhesive film has a first overlapping portion with the second adhesive film, and a width of the first overlapping portion ranges from 0.1 mm to 15 mm.

4. The battery cell according to claim 1, wherein the outer surface of the electrode assembly further comprises a first side face and a second side face opposite to the first side face, and the first side face and the second side face are respectively provided between the first surface and the second surface;
the second adhesive layer is disposed between the second adhesive film and the first side face;
the battery cell further comprises a third adhesive layer, the third adhesive layer is adhered to the second end face and extends from the second end face to the first surface and the second surface separately, and the third adhesive layer is disposed between the second adhesive film and the second side face; and
in the width direction of the electrode assembly, the second adhesive layer and/or the third adhesive layer respectively have a second overlapping portion with the second adhesive film, and a width of the second overlapping portion ranges from 0.1 mm to 15 mm.

5. The battery cell according to claim 4, wherein the first adhesive film is disposed between the second adhesive layer and the first side face, and/or between the third adhesive layer and the second side face.

6. The battery cell according to claim 5, wherein the first adhesive film has a third overlapping portion between the bottom side and the second adhesive layer and/or between the bottom side and the third adhesive layer, and a width of the third overlapping portion ranges from 0.1 mm to 15 mm.

7. The battery cell according to claim 1, wherein the electrode assembly is formed by stacking or winding an anode electrode plate, a separator, and a cathode electrode plate that are disposed in sequence; in a length direction of the electrode assembly, two sides of the anode electrode plate exceed beyond two corresponding sides of the cathode electrode plate; two sides of the separator respectively exceed beyond two corresponding sides of the anode electrode plate; and the first surface is one side of the outermost cathode electrode plate in the electrode assembly; and
in the length direction of the electrode assembly, one side of the first adhesive film is adhered to the first surface, and the other side of the first adhesive is adhered to an area of the outermost separator in the electrode assembly that exceeds beyond the corresponding cathode electrode plate and that does not exceed beyond an end face of the corresponding separator.

8. The battery cell according to claim 7, wherein a product of an overlapping area between the first adhesive film and the separator, and an adhesive force therebetween is defined as a third adhesive force; a product of an overlapping area between the cathode electrode plate and the separator, and an adhesive force therebetween is defined as a fourth adhesive force; and the third adhesive force is greater than the fourth adhesive force.

9. The battery cell according to claim 7, wherein the adhesive force between the first adhesive film and the separator is greater than or equal to 0.05 N/mm.

10. The battery cell according to claim 7, wherein an adhesive force between the first adhesive film and the cathode electrode plate is greater than or equal to 0.05 N/mm.

11. The battery cell according to claim 1, wherein the battery cell further comprises a fourth adhesive layer adhered to the second surface, the second surface is a surface on which a terminating end of the electrode assembly is located, one end of the first adhesive layer is adhered to one end of the second adhesive film located on the top side, the other end of the first adhesive layer is adhered to one end of the fourth adhesive layer, and the second adhesive layer on the second surface is adhered to the other end of the fourth adhesive layer.

12. The battery cell according to claim 1, further comprising an encapsulating film, the encapsulating film comprises a first groove and a second groove that are configured to accommodate the electrode assembly, a depth of the first groove is less than that of the second groove, the first surface is opposite to a bottom face of the first groove, and the second surface is opposite to a bottom face of the second groove.

13. A battery, comprising:
a housing; and
a battery cell disposed in the housing;
the battery cell comprises:
an electrode assembly, a first adhesive layer, a second adhesive layer, a first adhesive film, and a second adhesive film;
wherein an outer surface of the electrode assembly comprises a first surface, a first end face, a second surface, and a second end face that are connected in sequence; the first surface is provided opposite to the second surface, and the first end face is provided opposite to the second end face;
the first adhesive layer is adhered to the first end face and extends from the first end face to the first surface and the second surface separately, and a side of the first surface provided with the first adhesive layer is defined as a top side;
the second adhesive layer is adhered to the second end face and extends from the second end face to the first surface and the second surface separately, and a side of the first surface provided with the second adhesive layer is defined as a bottom side;
the first adhesive film is adhered to the top side and/or the bottom side; and
the second adhesive film is adhered to the first surface, and two ends of the second adhesive film are adhered to the top side and the bottom side respectively;
wherein a first adhesive force between the first adhesive film and the first surface is greater than a second adhesive force between the second adhesive film and the first surface.

14. The battery according to claim 13, wherein a ratio of the first adhesive force to the second adhesive force is greater than or equal to 1 and less than or equal to 5.

15. The battery according to claim 13, wherein in a width direction of the electrode assembly, the first adhesive film has a first overlapping portion with the second adhesive film, and a width of the first overlapping portion ranges from 0.1 mm to 15 mm.

16. The battery according to claim 13, wherein the outer surface of the electrode assembly further comprises a first side face and a second side face opposite to the first side face, and the first side face and the second side face are respectively provided between the first surface and the second surface;
the second adhesive layer is disposed between the second adhesive film and the first side face;
the battery cell further comprises a third adhesive layer, the third adhesive layer is adhered to the second end face and extends from the second end face to the first surface and the second surface separately, and the third adhesive layer is disposed between the second adhesive film and the second side face; and
in the width direction of the electrode assembly, the second adhesive layer and/or the third adhesive layer respectively have a second overlapping portion with the second adhesive film, and a width of the second overlapping portion ranges from 0.1 mm to 15 mm.

17. The battery according to claim 16, wherein the first adhesive film is disposed between the second adhesive layer and the first side face, and/or between the third adhesive layer and the second side face.

18. The battery cell according to claim 17, wherein the first adhesive film has a third overlapping portion between the bottom side and the second adhesive layer and/or between the bottom side and the third adhesive layer, and a width of the third overlapping portion ranges from 0.1 mm to 15 mm.

19. The battery cell according to claim 13, wherein the electrode assembly is formed by stacking or winding an anode electrode plate, a separator, and a cathode electrode plate that are disposed in sequence; in a length direction of the electrode assembly, two sides of the anode electrode plate exceed beyond two corresponding sides of the cathode electrode plate; two sides of the separator respectively exceed beyond two corresponding sides of the anode electrode plate; and the first surface is one side of the outermost cathode electrode plate in the electrode assembly; and
in the length direction of the electrode assembly, one side of the first adhesive film is adhered to the first surface, and the other side of the first adhesive film is adhered to an area of the outermost separator in the electrode assembly that exceeds beyond the corresponding cathode electrode plate and that does not exceed beyond an end face of the corresponding separator.

20. The battery cell according to claim 19, wherein a product of an overlapping area between the first adhesive film and the separator and an adhesive force therebetween is defined as a third adhesive force, a product of an overlapping area between the cathode electrode plate and the separator and an adhesive force therebetween is defined as a fourth adhesive force, and the third adhesive force is greater than the fourth adhesive force.
